(19) United States
(12) Patent Application Publication
(10) Pub. No.: US 2009/0093992 A1
(43) Pub. Date: Apr. 9, 2009

(54) Pedometer

(76) Inventor: Andrea Wimmer, Grosshelfendorf (DE)

Correspondence Address: IP STRATEGIES, 12 1/2 WALL STREET, SUITE E, ASHEVILLE, NC, 28801, US

(21) Appl. No.: 12/297,556

(22) PCT Filed: Apr. 2, 2007
(86) PCT No.: PCT/DE07/00599

§ 371 Date: Oct. 17, 2008

(30) Foreign Application Priority Data
Apr. 21, 2006 (DE) 102006018545.5

(51) Int. Cl. G01P 15/00; G06F 15/00; A01K 13/00

(52) U.S. Cl. 702/141; 73/490; 168/18

(57) ABSTRACT

The invention relates to a method for measuring the number of steps of an animal moving on four legs, according to which an acceleration sensor (38, 29) detects acceleration in a plane in which the animal is moving, and wherein the acceleration is caused by the locomotion of the animals' leg. The invention further relates to an apparatus (1) for detecting the distance covered by the animal moving on four legs, comprising a housing (3) and a measuring unit provided within the housing, wherein the measuring unit comprises a step counting unit (22) comprising at least one acceleration sensor (38, 29), wherein the acceleration sensor (38, 29) is arranged inside the housing (3) such that it detects an acceleration substantially parallel to the plane in which the animal is moving. Moreover, the invention relates to a system which comprises an apparatus (1) for detecting the distance covered by an animal moving on four legs and a receiving unit (2), as well as a tendon boot (30) for application to a fetlock of an animal moving on four legs, in particular a horse, wherein the tendon boot (30) has means (33) for fastening the apparatus (1).

The invention relates to a method of pedometric sensing the locomotion of a four-legged animal, to a device for sensing the distance covered by the locomotion of a four-legged animal, to a system including a device for sensing the distance covered by the locomotion of a four-legged animal and to a receiver module, as well as to a tendon boot or gaiter for application to a fetlock of a four-legged animal in locomotion.

Stride/step counters or pedometers are known from prior art. They are, for instance, being made use of by participants in walking or running sports events such as hiking or a marathon to record the distance covered in learning therefrom, for example, the benefits of training or condition. The pedometers employed for this purpose are usually worn on the hip or on a belt secured to a leg or arm to detect jolts caused by walking or running. A conventional pedometer is configured such that an acceleration sensor is provided in the interior of a housing. One example of a mechanical acceleration sensor is a pendulum which oscillates about its axis on every step of the wearer and which is actively connected to a counter designed to count the number of steps. In such conventional pedometers the axis of rotation of the pendulum is disposed in a horizontal plane so that the pendulum is caused to oscillate in a plane vertical thereto by the jolts of each step taken by the wearer. Each oscillation triggered by the step taken by the wearer is then counted and indicated e.g. by a display. From the length of each step taken during walking or running and the detected number thereof the distance covered by the wearer can then be established. Conventional pedometers make this conversion automatically when the corresponding step length of the wearer is entered into the pedometer.

It has been discovered, however, that these known pedometers reacting to jolts in the locomotion of a human-being fail to react to the leg motion of a four-legged animal, such as a horse having such a pedometer attached to its fetlock. One possible cause for this is that the stride of four-legged animals, especially of horses, follows a motion profile different to that of a human-being. In addition to this, four-legged animals such as horses or ponies are adept in moving in many different ways such as walking, trotting, galloping, tölt or ambling and the like. Thus, conventional pedometers cannot be put to use on horses or on other four-legged animals, although it is particularly important in riding events to record the distance covered e.g. over unfamiliar terrain in performing a training routine and to gain information from the results as to the success in training and condition of the horse.

One possibility of keeping track of distances covered by a horse is to use a global position system (GPS). But this solution is very expensive and depends on receiving the position data communicated by satellite, thus making this method useless in locations where there is no assurance of a good reception. On top of this a GPS is delicate and significantly bigger than a normal pedometer. This is why its use on a horse or other animal is restricted. And because of its high price as a valuable instrument with many uses, not only on a horse but also e.g. in a car, there is a greater risk of it being stolen.

The object of the present invention is thus to provide a method, a device for sensing the distance covered by the locomotion of a four-legged animal, a system making use of the device, as well as a tendon boot which now makes it possible to precisely sense the number of strides taken by a four-legged animal at low cost by the device being securely positioned on the animal and which is of no detriment to locomotion of the animal when attached to its leg.

This object is achieved by means of a method having the features as set forth in claim 1, by a device having the features as set forth in claim 12, by a system having the features as set forth in claim 27 and by a tendon boot having the features as set forth in claim 32. Advantageous further embodiments of the invention are defined in each of the sub-claims.

In accordance with the invention a method of pedometric sensing the locomotion of a four-legged animal is provided wherein at least one acceleration sensor senses an acceleration in a plane in which the animal is moving and wherein the acceleration is caused by the leg motion of the animal. It has been surprisingly discovered that this way of sensing motion is far more reliable than that as already known for sensing jolts or accelerations in exploiting an oscillation in a vertical plane. By sensing the acceleration in the motion plane of the animal, i.e. by exploiting an oscillation in an essentially horizontal plane, pedometric sensing a four legged animal is now precise and simple, meaning when the animal moves in the plane the acceleration is now sensed in the horizontal instead of sensing the jolts in the vertical caused by locomotion. This now makes it possible to sense the number of strides taken by a horse, pony, camel or the like, irrespective of the gait, e.g. walking, trotting, galloping, tölt or ambling of the animal.

To sense the acceleration use is made preferably of a pendulum, the plane of oscillation of which is essentially parallel to the plane in which the animal is moving. Preferably the pendulum comprises a pendulum axis of rotation oriented substantially parallel to a longitudinal axis of a leg of the animal (i.e. vertical) at which sensing is done. It is furthermore preferred that a pendulum axis is oriented perpendicular to the longitudinal axis of the leg of the animal at which sensing is done. Using a pendulum as the motion sensor makes for a cost-effective and simple variant of a pedometer.

In addition it is of advantage when sensing the acceleration is done purely mechanically, eliminating the need of a power supply which is prone to malfunctioning occasionally to the detriment of the resulting data.

An alternative embodiment provides for sensing the acceleration by electric, electromechanical or electromagnetic ways and means. These sensors are especially precise and sensitive and take up little room in the housing of the device.

But it is particularly of advantage when the acceleration is sensed both mechanically and electronically or electromagnetically so that precise sensing by means of the mechanical sensors is still possible even when the electric or electromagnetic sensors are useless due to no power being available, for example. In this arrangement it would also be of an advantage to arrange or adapt the various sensors such that further components of the motion in addition to those in the motion plane can be sensed in thus being able to achieve an even more precise result.

In accordance with a further preferred embodiment of the pedometric method the length of the distance covered is determined from the sensed number of strides. Preferably the conversion from a mode indicating the distance in kilometers can be switched over to a mode which indicates the distance in miles.

Preferably by means of the method, differing gaits of the animal are sensed and used to determine the distance covered.

In a further aspect of the invention the sensed data is communicated to a receiver module which evaluates the data. Preferably the data is wireless communicated via an infrared interface, but wired communication is just as possible as connected e.g. via an USB interface.

Provided furthermore in accordance with the invention is a device for sensing the distance covered by the locomotion of a four-legged animal comprising a housing and a sensing assembly provided in a housing, the sensing assembly including a pedometric module comprising at least one acceleration sensor, the latter being arranged in the housing such that it senses an acceleration essentially parallel to a plane in which the animal is moving. As already mentioned, sensing the acceleration in the motion plane of the animal now makes it possible to sense the number of strides precisely by simple ways and means.

In a preferred embodiment the acceleration sensor comprises a pendulum, the plane of oscillation of which is essentially parallel to the plane in which the animal is moving. Preferably a pendulum axis of rotation (D) is oriented essentially parallel to a longitudinal axis of a leg of the animal to which the device is securable (i.e. vertical) whereby a pendulum axis (A) is oriented perpendicular to the longitudinal axis of the leg of the animal to which the device is securable. The device is securable to the side of the leg of the animal so that every stride causes the pendulum to oscillate to and fro in the locomotion direction.

Preferably the housing of the device is configured water-tight and shock-proof. This is particularly of advantage since the animal, especially a horse, carrying the device on its fetlock may still wade through water without the device being ruined or malfunctioning.

In a preferred embodiment in which electronic or electromagnetic acceleration sensors are provided, these are preferably piezoresistive or magnetoresistive acceleration sensors. Where piezoresistive acceleration sensors are concerned which make use of the piezoresistive effect, an inert mass of silicon is suspended by means of a thin flexural beam. When the sensor is accelerated, the mass deflects the beam from its resting position because of its inertia. Piezoresistances applied to the beam change their electrical resistance due to the resulting mechanical stress. Piezoresistive acceleration sensors have the advantage that they can be expanded into two or even three-dimensional acceleration sensors capable of sensing the acceleration in two or three different directions. It may also be of an advantage to provide at least one amplifier for amplifying the pulses triggered by the motion of the animal.

In yet a further preferred embodiment there is provided in the housing of the device a processor, particularly a microprocessor which processes the data furnished by pedometric sensing. It is thus possible to determine from the sensed data by means of the processor the following parameters and data: power of a leg of the horse, stamina, jumping force, locomotion response, detecting irregularities in locomotion (i.e. due to illnesses such as, for example, lameness), the distance covered, energy consumption, e.g. in consumed calories, motion profile (individual gait lengthenings or shortenings), etc.

It is particularly preferred that the device comprises a transmitter to communicate the sensed data to an external receiver module. In this case it is possible that the device merely communicates raw data with all and any further processing of the data being done in an external module to thus realize an even more compact design of the device. However, it is just as possible that the device can communicate both raw data as well as data already having been processed in a native CPU to an external module, so that the latter merely receives and displays the data. Preferably data communication is wireless via an infrared interface, but it is just as possible that the device additionally comprises an USB interface for communicating the data to an external instrument.

For orientation or for positional sensing the distance covered it is particularly preferably that the device includes a compass.

It is particularly preferred when the animal carries at least on one further leg a further pedometric device each device communicating to the other via transmitter and receiver modules; thus, for instance, the averages of two results in sensing can be formed to determine the distance even more precisely.

Provided furthermore in accordance with the invention is a system comprising a device for sensing the distance covered by locomotion of a four-legged animal of the kind as described above as well as a receiver module featuring means for evaluating the data communicated as received by the device. This arrangement has the advantage that the receiver module is located separately from the device which is to be located above the hoof on the leg of the animal for pedometric sensing, and may thus be worn, for example, on the wrist of a rider like a watch. This makes it much easier for the rider to view the data as sensed and received via the display sparing him the discomfort of having to locate himself unfavorably since the data cannot be viewed from the saddle.

It is particularly preferred when both the device and the receiver module each have a transmitter and receiver so that there is a free exchange of data in both directions. Such a configuration makes it possible for a rider saddled on the animal to, for example, manually input data into the device, reprogram the data or to switch to another mode via a data entry module provided on a housing of the receiver module.

To secure the device to the animal or its leg above the hoof a fastener means is preferably provided on the housing, particularly preferred being a fastener means in the form of Velcro fastener straps wrapping the leg of the animal and joined together by a Velcro fastener. This is a particularly simple and low-cost solution for securing the device on the animal, particularly side-mounted on the leg of the animal.

In accordance with the invention there is provided a tendon boot for applying to a fetlock of a four-legged animal in locomotion particularly of a horse and which comprises means for securing the pedometric device to the animal. This has the advantage that the device itself then has no need of a fastening means, it instead being directly pocketed in the tendon boot on the fetlock of the horse where it, in addition, is safely protected from damage due to external effects.

Preferably, therefore, the tendon boot features a pocket in which the device can be accommodated and which can be closed to prevent the device from dropping out, becoming lost or broken in a fast gait of the horse or when jumping over an obstacle.

An example aspect of a device in accordance with the invention for sensing the distance covered by the locomotion of a four-legged animal is illustrated simplified in the drawing as is detailed in the following description in which:

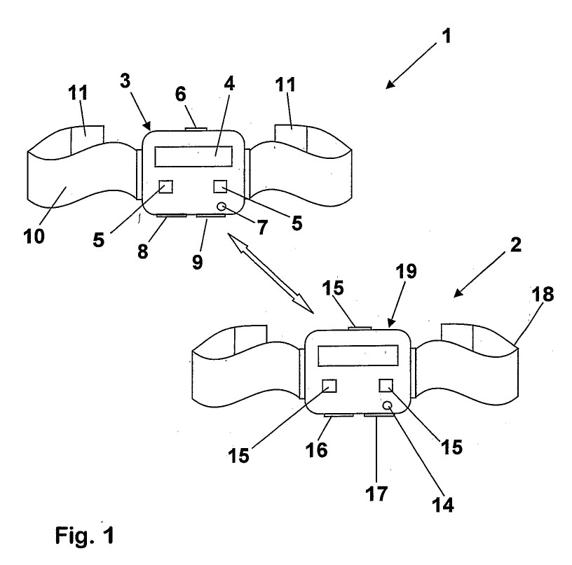

FIG. 1 is a front view of a device in accordance with the invention for sensing the distance covered by locomotion of a four-legged animal.

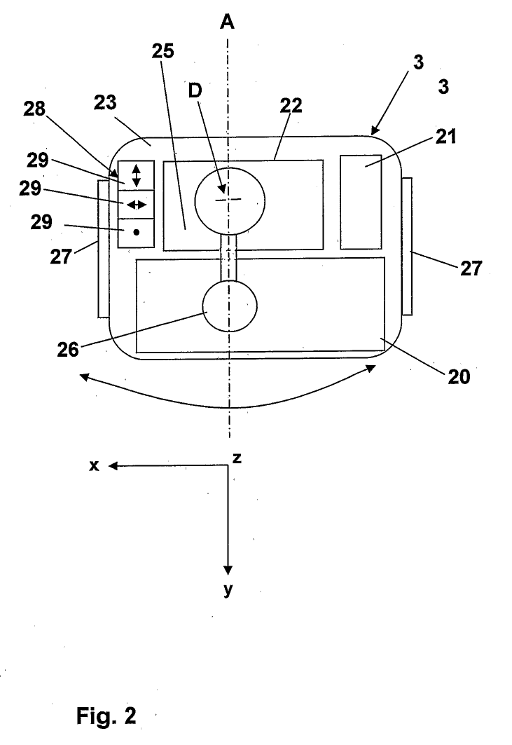

FIG. 2 is a diagrammatic top-down view of the device in accordance with the invention as shown in FIG. 1;

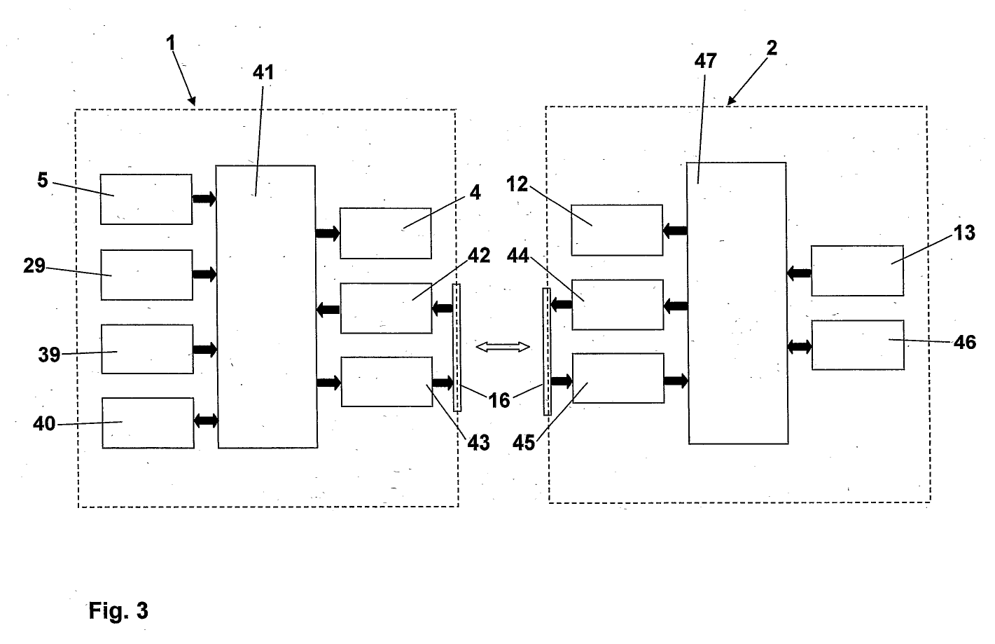

FIG. 3 is a block diagram of the system in accordance with the invention;

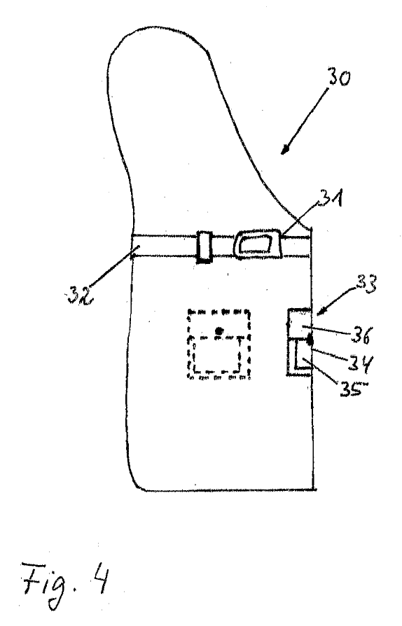

FIG. 4 is a side view of a tendon boot in accordance with the invention.

Referring now to FIG. 1 there is illustrated a device 1 for sensing the distance covered by locomotion of a four-legged animal, respectively the system in accordance with the invention comprising the device 1 and a receiver module 2. The device 1 comprises a housing 3 which in this case is made of a plastics material, although it is just as possible that it be made of other materials such as, for instance, stainless steel or the like, as long as it is assured that the housing 3 is water-tight and shockproof. The housing 3 is fronted by a display 4 for indicating the sensed data such as, for example, the number of strides sensed or the data determined therefrom such as, for example, length of the distance covered. In addition, the display 4 may also serve to indicate data such as time of day, date, temperature, etc. Further, two input buttons 5 are arranged at the front of the housing 3. The operation of the device by a user is possible by means of these input buttons 5. Thus, the input buttons 5 can be used to switch over to another mode of the device, to switch the display and to enter specific data as needed to determine the distance covered from the number of strides sensed and as may also serve for further evaluation of the sensed data. Via the input buttons 5 a user can enter e.g. the stride length in accordance with the gait (walking, trotting, galloping, tölt, ambling). It is also possible by means of the input buttons 5 to enter the riding height of the horse or pony in relation to the stride length.

Provided on the top of the housing 3 is an ON/OFF switch 6 for switching the device 1 on and off. In addition in the ON position of the ON/OFF switch 6 the device 1 automatically switches to the energy saving sleep mode after a certain time, for example, 10 minutes without the device 1 having been actuated or having performed any operations. The front of the housing 3 also features a reset button 7 for resetting the electronics (not shown) accommodated in the interior of the housing 3 of the device 1. The bottom of the housing 3 includes an infrared interface 8 for wireless data communication or data exchange (indicated by the arrow in FIG. 1) with the receiver module 2 or, for instance, with a further redundant device 1 carried by the horse e.g. on its second front leg or also on a rear leg. When the horse carries several devices 1 the sensed values can be e.g. averaged, enhancing reliability of the data. This also eliminates the risk of obtaining no results whatsoever when a device 1 is defunct when riding out the horse. Provided furthermore on the bottom of the housing 3 is an interface 9, in this case a USB interface for wired communication of the data for evaluation, processing or storing by an external instrument. To secure the device 1 to the leg of an animal (not shown) particularly to the fetlock of a horse Velcro fastener straps 10 are provided on each side of the device 1 designed to wrap the leg and joined together by their fastener ends 11 featuring hooks and eyelets. However, the Velcro fastener straps 10 are provided releasable on the device 1 so that they can be removed when it is intended to pocket the device 1 in a tendon boot carried by the horse on its fetlock.

The receiver module 2 as shown here has the same outward appearance as the device 1 with a housing 19 comprising a display 12, two input buttons 13 for user entry control of the receiver module 2 and a reset button 14 on the front for resetting the electronics, an ON/OFF switch 15 on the top and an infrared interface 16 as well as an USB interface 17 on the bottom of the housing 19 for data communication. It is, however, just as well possible to arrange the interfaces and switches suitably located elsewhere on the housing 19, for instance, on the back. The receiver module 2 also features a wrist strap, in this case likewise in the form of a Velcro fastener strap 18, so that the user can wear the receiver module 2 on his wrist, it being just as well possible to fit a leather or nylon wrist strap to the receiver module 2 as is used conventionally on wrist watches. The wrist strap is attached releasable to the receiver module 2 so that the latter can also be secured e.g. to a belt or some other garment item by means of a clip (not shown) provided on the back of the receiver module 2. The receiver module 2 is furthermore engineered compatible to process data received from the device 1 by the housing 19 accommodating a processor (CPU) for the corresponding data processing. This, however, is not necessary when the device 1 itself is rendered compatible for processing all data sensed. The device 1 and the receiver module 2 are battery operated, their housings 3, 19 accordingly each featuring a recess (not shown) in the back for locating the batteries under a cover.

The device 1 and the receiver module 2 form together the system in accordance with the invention which, as explained above can be expanded by the further pedometer modules attached to further legs of the animal or further receiver modules 2 for the rider or his trainer.

Referring now to FIG. 2 there is illustrated a diagrammatic top-down view of the device 1 shown in FIG. 1. The housing 3 is made up of a bottom half 23 and a top half (not shown) forming the cap. Side mounted on the housing 3 are brackets 27 to which the Velcro fastener straps 18 can be secured, by means of which the device 1 can be secured to the leg e.g. of a horse. Housed in the bottom half 23 are an electronics module 20 comprising a microprocessor as well as the transmitter module and receiver module, a power supply module 21 and a pedometric module 22. A pendulum 25 having a pendulum axis A and a weight 26 secured thereto is provided in the housing. The pendulum 25 is biased by a spring (not shown). The force of the pendulum is adjustable via the spring. It is the effect of weight 26 that causes the pendulum 25 to oscillate on every stride of the horse, the counter mechanism being automatically powered, resulting in a mechanical acceleration sensor 38. In this arrangement the pendulum axis A oscillates in a horizontal x-y plane about a pendulum axis of rotation D oriented in the vertical z direction parallel to the longitudinal axis of a leg to which the device 1 can be applied. This means that the pendulum axis of rotation D is oriented perpendicular to the longitudinal axis of the leg of the horse and the pendulum axis of rotation D is oriented in the vertical z direction parallel to the longitudinal axis of the leg to which the device 1 is secured. When the device 1 is secured to the side of the leg of the animal the pendulum 25 oscillates to and fro due to the locomotion on every stride in the x-y plane in the locomotion direction of the animal. It is this arrangement, which unlike with conventional pedometers the pendulum axis of rotation is oriented parallel to the longitudinal axis of the leg and not perpendicular thereto, each stride in locomotion is sensed in any gait of a horse, pony, camel or the like. In this embodiment the device 1 comprises both a mechanically acting acceleration sensor in the form of the pendulum 25 which already suffices for sensing the data and an electronic acceleration sensor module 28. In this case the electronic acceleration sensor module 28 is made up of three one-dimensional acceleration sensors 29 each sensing acceleration in the x direction, in the y direction and in the z direction. However, also a two or three-dimensional acceleration sensor 29 can be put to use. In a further embodiment the device is operated exclusively by electronic acceleration sensors 29 sensing all profiles and all components of the motion. The resulting pediometric data is communicated from pedometric module 22 to the electronics module 20 for further processing and/or communication to the receiver module 2. Provided furthermore in the housing 3 is a transmitter module and a receiver module for data communication. Since in the embodiment exclusively working with electronic acceleration sensors 29 all components of the motion are sensed, this embodiment is particularly suitably for sensing deviations from the normal motion profile in thus enabling a lameness, for example, to be detected.

Referring now to FIG. 3 there is illustrated a block diagram of the system in accordance with the invention comprising the device 1 and the receiver module 2. As already explained above, the system is designed modular for extension. The device 1 comprises a microprocessor 41 which receives data from the input buttons 5, the acceleration sensors 29 as well as in the case as shown here from a temperature sensor 39. Further sensor modules can be provided for sensing a wealth of different data and for communicating the data to the microprocessor 41. Thus, for instance, a compass or a tilt sensor may be provided. It is additionally also possible to dispose between the sensors and the microprocessor 41 an amplifier and/or filter (not shown) for amplifying the detected signals or pulses, Provided furthermore is a data exchange between the microprocessor 41 and a memory 40. The memory 40 is adapted to store the data entered by the user such as, for example, the stride lengths in accordance with the various gaits or also in accordance with various horses, and it, in addition, storing the data resulting e.g. as the number of strides per ride as well as the resulting data as established by the microprocessor, such as distance covered, etc. The memory 40 can also store predetermined and/or completed training units. The microprocessor 41 is furthermore adapted to compute parameters from the sensed data providing information as to the power of a leg of the horse, as to the acceleration capacity, stamina, jumping force, locomotion response, energy consumption, temperature, circulation, motion profile (individual gait lengthenings or shortenings), etc. The sensed and computed data is forwarded to the display 4 for indication or can be retrieved via the input buttons 5 on the display 4. The device 1 features a transmitter 43 and a receiver 42 for data communication by infrared beaming to the receiver module 2 via an infrared interface 16. However, it is just as possible also to wireless communicate the data to the receiver module 2, this requiring a corresponding change in the configuration of the device 1. The data output by the transmitter 43 of the device 1 is received by the receiver 45 of the receiver module 2 and communicated to a microprocessor 47. The microprocessor 47 can pass on the received data when retrieved via the input buttons 13 to the display 12 for indication there; it itself, however, also possibly being capable of processing the received data and passing the data on by a transmitter 44 to an external instrument or back to the device 1.

Referring now to FIG. 4 in conclusion there is illustrated a side view of a tendon boot 30 which can be wrapped around the fetlock of a horse (not shown). The tendon boot 30 is made of leather, but may be made of a nylon material or any other material suitable for the purpose involved. The tendon boot is secured to the fetlock of the horse by a belt 32 for closing by a buckle 31, it being, however, just as well possible to also provide a plurality of belts. Also possible, should the tendon boot be made of a nylon or cotton material, is to use one or more Velcro fasteners. Fronting the tendon boot 30 (shown here on the right in the FIG.) is a means 33 for securing or accommodating the device 1 in the form of a pouch 34. The pouch 34 is applied to the surface of the tendon boot 30, but may just as well be worked into the material of the tendon boot 30. The pouch 34 features a window 35 of a transparent material such that the display 4 of the device 1 can still be viewed when the device 1 is pocketed in the pouch 34. Furthermore the pouch 34 comprises a flap 36 covering the top opening through which the device 1 can be inserted into the pouch 34 and can be snapped shut by means of a snap fastener 37 or any other equivalent means, thus safely accommodating and preventing the device 1 from becoming unpocketed in fast locomotion or jumping of the horse. The broken lines characterize another position suitably for locating the pouch 34 on or in the tendon boot 30.

1. A method of pedometric sensing the locomotion of a four legged-animal wherein at least one acceleration sensor senses an acceleration in a plane in which the animal is moving and wherein the acceleration is caused by the leg motion of the animal.

2. The method as set forth in claim 1 wherein to sense the acceleration a pendulum is used, the plane of oscillation of which is essentially parallel to the plane in which the animal is moving and the pendulum axis of rotation of which is oriented essentially parallel to a longitudinal axis of a leg of the animal at which sensing is performed.

3. The method as set forth in claim 2 wherein a pendulum axis is oriented perpendicular to the longitudinal axis of the leg of the animal at which sensing is performed.

4. The method as set forth in claim 1 wherein the acceleration is sensed mechanically.

5. The method as set forth in claim 1 wherein the acceleration is sensed electronically, electromechanically or electromagnetically.

6. The method as set forth in claim 1 wherein the acceleration is sensed mechanically and electronically.

7. The method as set forth in claim 1 wherein the number of strides is sensed by the oscillation of the pendulum and the length of the distance covered is determined from the sensed number of strides.

8. The method as set forth in claim 1 wherein differing gaits of the animal are sensed and used to determine the distance covered.

9. The method as set forth in claim 1 wherein the sensed and determined data is indicated on a display.

10. The method as set forth in claim 1 wherein the sensed data is communicated to a receiver module which evaluates the data.

11. The method as set forth in claim 10 wherein the communication of the data is performed wireless via an infrared interface.

12. A device for sensing the distance covered by the locomotion of a four-legged animal comprising a housing and a sensing assembly provided in the housing, the sensing assembly including a pedometric module comprising at least one acceleration sensor, wherein
the acceleration sensor is arranged in the housing such that it senses an acceleration essentially parallel to a plane in which the animal is moving.

13. The device as set forth in claim 12, wherein
the acceleration sensor comprises a pendulum, the plane of oscillation of which is oriented essentially parallel to the plane in which the animal is moving and the pendulum axis of rotation of which is oriented essentially parallel to a longitudinal axis of a leg of the animal to which the device is securable and whereby a pendulum axis is oriented perpendicular to the longitudinal axis of the leg of the animal to which the device is securable.

14. The device as set forth in claim 12, wherein
the pendulum mechanically actuates a counter mechanism of the pedometric module.

15. The device as set forth in claim 12,
wherein
the pendulum actuates a counter mechanism of the pedometric module electronically or electromagnetically.

16. The device as set forth in claim 12,
wherein
the housing is closed off water-tight.

17. The device as set forth in claim 12,
wherein
the housing is configured shock-proof.

18. The device as set forth in claim 12,
wherein
at least one further electronic acceleration sensor is provided which senses an acceleration in a horizontal direction and/or senses an acceleration in a vertical direction.

19. The device as set forth in claim 18,
wherein
the electronic acceleration sensor is a piezoresistive or magnetoresistive acceleration sensor.

20. The device as set forth in claim 12,
wherein
provided in the housing is furthermore a microprocessor which determines the from the sensed number of strides the length of the distance covered, the energy consumption, the gait profile, changes in the motion profile, the acceleration capacity and the stamina.

21. The device as set forth in claim 12,
wherein
provided furthermore in the housing is a temperature sensor which determines the temperature of the carrier of the device, particularly of the animal in four-legged locomotion.

22. The device as set forth in claim 12,
wherein
the housing is provided with a means for securing the device to a leg of the animal, particularly in the form of Velcro fastener straps.

23. The device as set forth in claim 12,
wherein
the housing is provided with a display for displaying the sensed data and the date determined therefrom by the microprocessor.

24. The device as set forth in claim 12,
wherein
the device furthermore comprises a transmitter which communicates the sensed data and/or the data determined therefrom to a receiver module.

25. The device as set forth in claim 24,
wherein
data communication to the receiver module is wireless.

26. The device as set forth in claim 12,
wherein
the device comprises a compass, particularly a mechanical compass.

27. A system comprising a device for sensing the distance covered by the locomotion of a four-legged animal as set forth in claim 12 and a receiver module, the system comprising at least one microprocessor adapted to process and evaluate the data sensed by the device.

28. The system as set forth in claim 27 wherein the receiver module comprises a display for displaying the received and/or evaluated data.

29. The system as set forth in claim 27 wherein the receiver module is configured to be worn on a wrist of a user.

30. The system as set forth in claim 27 wherein the device comprises a receiver for sensing the distance covered by the locomotion of a four-legged animal.

31. The system as set forth in claim 27 wherein the receiver module comprises a transmitter.

32. A tendon boot for applying to a fetlock of a four-legged animal in locomotion, particularly a horse,
wherein
the tendon boot comprises a means for securing the device as set forth in claim 12.

33. The tendon boot as set forth in claim 32,
wherein
the tendon boot comprises a pouch configured to pocket the device for sensing the distance covered by the locomotion of a four-legged animal.

34. The tendon boot as set forth in claim 33,
wherein
the pouch is closable.
